(19) United States
(12) Patent Application Publication
(10) Pub. No.: US 2011/0000003 A1
(43) Pub. Date: Jan. 6, 2011

(54) Wetsuit made with a non-absorbent and quick drying fabric

(75) Inventor: Min-Chen Shiue, I-Lan Hsien (TW)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: SHEI CHUNG HSIN IND, CO. LTD.

(21) Appl. No.: 12/460,569

(22) Filed: Jul. 21, 2009

Related U.S. Application Data
(60) Provisional application No. 61/222,112, filed on Jul. 1, 2009.

(51) Int. Cl. B63C 11/04; B32B 5/02; B32B 5/18; D04B 1/22

(52) U.S. Cl. 2/2.15; 442/304; 442/315; 66/170

(57) ABSTRACT

A wetsuit having an outer and/or inner surface is manufactured from an improved non-absorbent and quick drying fabric. The improved non-absorbent and quick drying fabric is made of 100% non-absorbent fiber, selected from polyester, having a fineness ranging from 30 denier to 75 denier, and pre-processed with water repellent before being knitted, then knitted by a single circular knitting machine under a setting of 18˜44 gauge per inch. The result is an improved fine, thin, non-absorbent, and quick drying fabric, which prevents the penetration of water molecules. The improved non-absorbent and quick drying fabric is laminated with a rubber sponge material to form an improved non-absorbent and quick drying wetsuit material. Appropriate cutting and sewing processes are employed to finish the formation of a wetsuit and the improved non-absorbent and quick drying wetsuit is lighter and dries quicker when the wearer leaves the water since less water is absorbed by the wetsuit fabric as compared to a conventional wetsuit.

### CROSS-REFERENCE TO RELATED APPLICATIONS

This application claims priority from U.S. Provisional Patent Application Ser. No. 61/222,112 filed Jul. 1, 2009.

### BACKGROUND OF THE INVENTION

1. Field of the Invention

The present invention relates generally to the field of wetsuits used for diving, surfing and the like, and more specifically to an improved non-absorbent and quick drying fabric used to manufacture the outer and/or inner surface of a wetsuit. The wetsuit is made of the non-absorbent fiber which is pre-processed with the water repellent before being knitted, then knitted by a single circular knitting machine under a setting of 18˜44 gauge per inch to form an improved fine and thin fabric. The non-absorbent fiber is selected from polyester having a fineness ranging from 30 denier to 75 denier and the thickness of the knitted fabric is in the range of 0.3˜0.55 mm.

The present invention relates particularly to an improved non-absorbent and quick drying fabric used to manufacture the outer and/or inner surface of a wetsuit. The fabric has the ability to prevent the penetration of water molecules. The fabric is fine and has the function of non-absorbent and quick drying that provides the performance of drying quicker, a smoother sense of touch, longer life than smooth skin and glide skin and solves the drawback of wind-chill on a wearer after leaving the water.

2. Background Art

After wearing a conventional wetsuit for diving or related water sports activities, where the wearer is immersed in water, the fabric of the outer and/or inner surface of the wetsuit will absorb water and make the wetsuit wearer feel heavy, uncomfortable and cold caused by wind-chill, after the wearer leaves the water. There are some wetsuit manufacturers which have developed a method of production to have the fabric, used as the outer surface of a wetsuit, immersed in the water repellent to lessen the amount of water absorption that may reduce the above-noted drawbacks. However, this method has the disadvantage that the effects of water repellent will decrease with time due to repeated rubbing or washing. Also, it is not easy to glue to the rubber sponge or apply ink with printing, and the sense of touch is not smooth since the water repellent forms a hard and serrated film like a paper which covers the fabric after the immersing process.

There are some wetsuit manufacturers which have developed the method of production to replace the fabric that used to be the outer surface of a wetsuit with a smooth skin, flat neoprene, or glide skin, neoprene coated with PU, that are all non-absorbent to avoid the defect of water absorption to reduce the drawbacks of wind-chill mentioned above. However, this method has the disadvantage of the effects of having no aesthetic appeal since the smooth skin is a flat surface of neoprene that is black only, and the strength and the performance are less than a fabric laminated with neoprene.

It would be highly advantageous if it were possible to make the outer and/or inner surface of the wetsuit non-absorbent, to have a good sense of touch, and perform with strength and anti-friction that not only make the wetsuit aesthetically pleasing but also solves the drawback of wind-chill and lasts longer.

### SUMMARY OF THE INVENTION

The present invention relates to the field of wetsuits used for diving, surfing and the like, and more specifically to the outer and/or inner surface of an improved wetsuit made of a non-absorbent and quick drying fabric.

The improved non-absorbent and quick drying fabric is made entirely of non-absorbent yarn selected from polyester, pre-processed with water repellent before being knitted, and having a fineness ranging from 30 denier to 75 denier.

The non-absorbent yarn is knitted by a single circular knitting machine under a setting of 18˜44 gauge per inch to form a fine and thin fabric, which has the ability to prevent the penetration of water molecules and attachment of water.

The finished non-absorbent and quick drying fabric is at a weight of 60˜270 gram/M², a width of 50˜72 inches, an elongation capability in both the vertical and horizontal directions of 100˜300%, and having a thickness of 0.3˜0.55 mm.

The non-absorbent and quick drying fabric, as the outer and/or inner surface of the wetsuit, is laminated with a rubber sponge material to form an improved non-absorbent and quick drying wetsuit. Appropriate cutting and sewing process are employed to finish the formation of wetsuit.

Compared with conventional fabric used as the outer surface of a wetsuit, the improved non-absorbent and quick drying fabric of the present invention is light and offers excellent strength and anti-friction. The non-absorbent feature prevents the penetration of water molecules, solves the drawback of wind-chill, and lasts longer.

Compared with the developed smooth skin and glide skin used as the outer surface of a conventional wetsuit, the improved non-absorbent and quick drying fabric of the present invention has a pleasant feel, aesthetic design, and excellent strength that makes the wetsuit durable.

It is believed to be the first time that a wetsuit has been made of rubber sponge laminated with the fine, thin, non-absorbent and quick drying fiber pre-processed with water repellent before being knitted.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a flow chart showing the preferred process of making a wetsuit fabric of the present invention;

FIG. 2, comprising FIGS. 2A and 2B is a cross sectional view showing the macro and micro structure respectively of the fabric used to manufacture the present invention as the surface of a wetsuit;

FIG. 3 is the flow chart showing the process of making a wetsuit fabric of the conventional process; and

FIG. 4, comprising FIGS. 4A and 4B is a cross sectional view showing the macro and micro structure respectively of the fabric used to manufacture a conventional wetsuit.

### DETAILED DESCRIPTION OF A PREFERRED EMBODIMENT

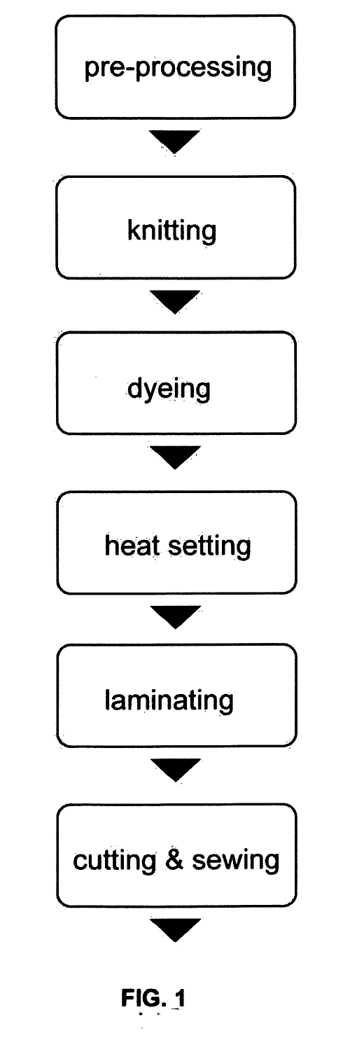

With reference to FIG. 1, the process of manufacturing the wetsuit of the present invention includes the steps of pre-processing (10), knitting (20), dyeing (30), heat setting (40), laminating (50), and cutting and sewing (60). The improved non-absorbent and quick drying fabric used to manufacture the outer and/or inner surface of wetsuit, is entirely made of a non-absorbent yarn, pre-processed with the water repellent before being knitted, then knitted by a single circular knitting machine under a setting of 18˜44 gauge per inch to form a fine and thin fabric, which has the ability to prevent the penetration of water molecules and attachment of water.

The improved non-absorbent and quick drying fabric is made of non-absorbent yarn selected from polyester having a fineness ranging from 30 denier to 75 denier.

The improved non-absorbent and quick drying fabric can prevent the penetration of water molecules and attachment of water that makes the outer and/or inner surface of the wetsuit dry when the wearer leaves the water, and makes the wearer feel dry, light, comfortable and reduces the impact of wind-chill.

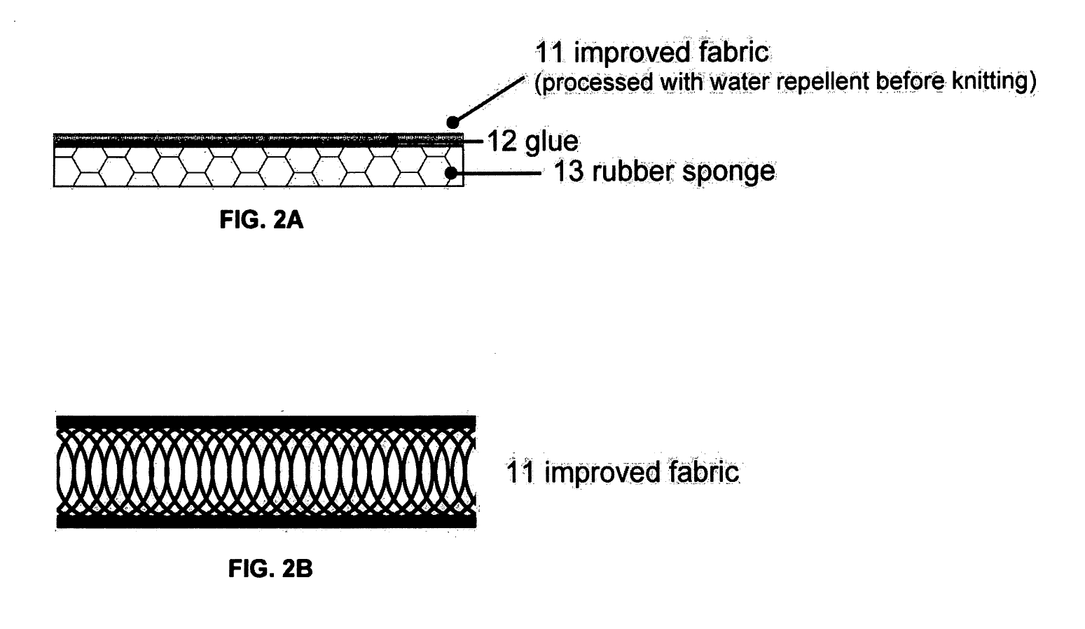

Since the water repellent is fully absorbed throughout and combined with the fiber of the improved non-absorbent and quick drying fabric, the effects of water repellent will last longer and offer better anti-friction even if the wetsuit is rubbed or washed or aged as shown in FIG. 2.

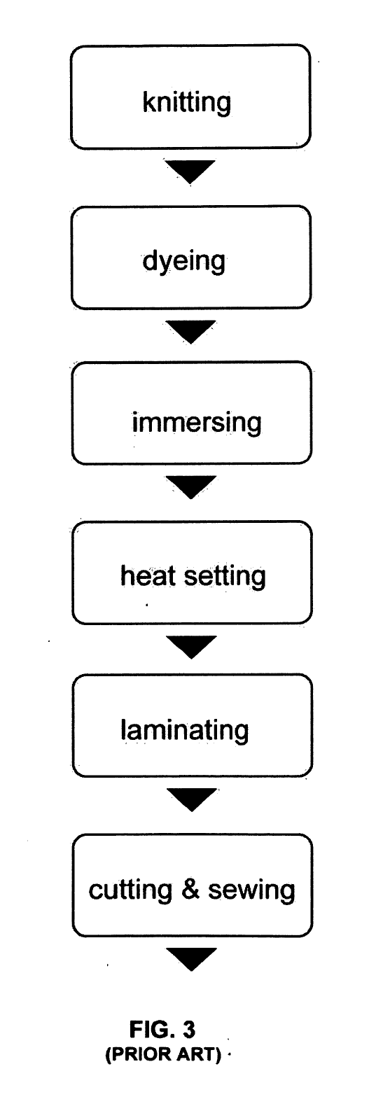

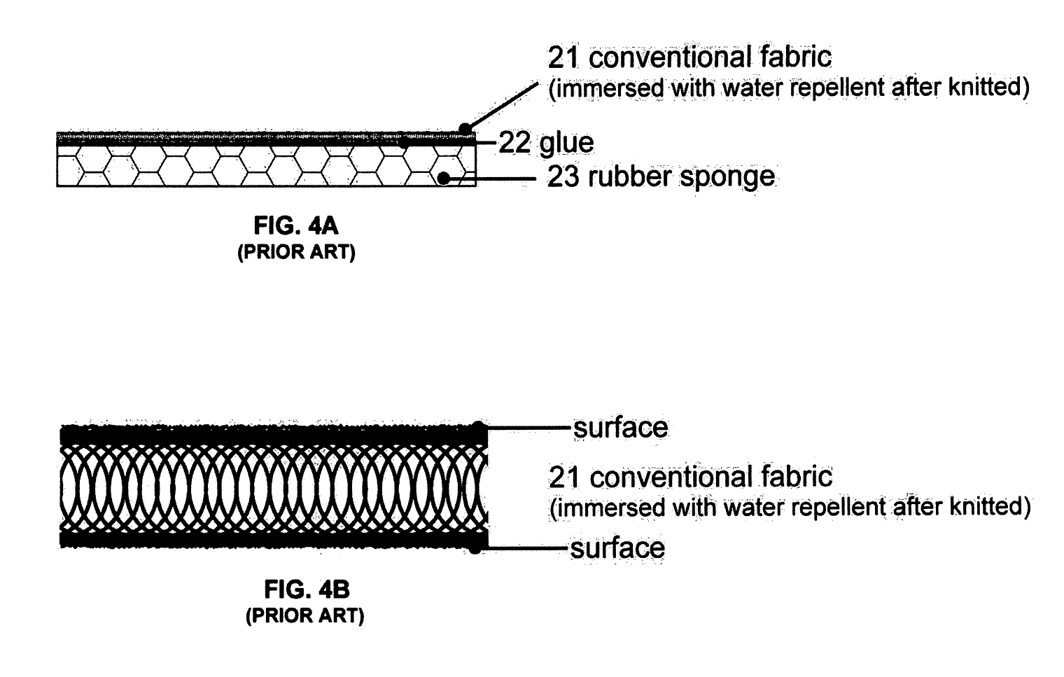

With reference to FIG. 3, the process of manufacturing the wetsuit of the conventional method includes knitting (10), dyeing (20), immersing (30), heat setting (40), laminating (50), and cutting and sewing (60). The conventional wetsuit is made of a normal fabric immersed with water repellent after knitting and dyeing and before heat setting that make the water repellent form a hard and serrated film, like a paper that covers the fabric, as shown in FIG. 4, and causes an unpleasant rough sense of touch. Since the water repellent is on the cover of the fabric only, the effects of the repellent will decrease and the water repellent will be eventually lost due to being rubbed or washed and that will lessen the durability of the wetsuit.

I claim:

1. A wetsuit having an outer and/or inner surface manufactured from an improved fabric made of a non-absorbent and quick drying material.

2. The improved non-absorbent and quick drying fabric recited in claim 1 made of non-absorbent yarn.

3. The improved non-absorbent and quick drying yarn recited in claim 2 made of polyester.

4. The improved non-absorbent and quick drying yarn recited in claim 2 having a fineness ranging from 30 denier to 75 denier.

5. The improved non-absorbent and quick drying yarn recited in claim 2 being pre-processed with a water repellent before being knitted.

6. The improved non-absorbent and quick drying yarn recited in claim 2 being knitted by a single circular knitting machine under a setting of 18˜44 gauge per inch.

7. The improved non-absorbent and quick drying yarn recited in claim 2 having a thickness of 0.30˜0.55 mm.

8. The improved non-absorbent and quick drying fabric recited in claim 1 laminated with a rubber sponge material to form an improved non-absorbent and quick drying wetsuit fabric.
